(19) United States
(12) Patent Application Publication
(10) Pub. No.: US 2012/0089413 A1
(43) Pub. Date: Apr. 12, 2012

(54) Health Tracking and Management

(76) Inventor: Edward Balassanian, Kirkland, WA (US)

(21) Appl. No.: 13/006,296

(22) Filed: Jan. 13, 2011

Related U.S. Application Data
(60) Provisional application No. 61/390,506, filed on Oct. 6, 2010.

(51) Int. Cl. G06Q 50/00; G06Q 10/00

(52) U.S. Cl. 705/2

(57) ABSTRACT

A consumer-centric health portal for individuals to track quantitative health data, receive a health grade and receive qualitative feedback. An individual's health data is measured, compared and graded providing a deep understanding of their health, how their health relates to similar individuals and key factors correlating to their health grade. Health grades, in conjunction with qualitative feedback, promote motivation and learned optimism promoting individuals to improve their health. In turn, health grades are targetable by and service providers, while protecting an individual's privacy.

### CROSS-REFERENCE TO RELATED APPLICATIONS

This application claims the benefit of Provisional Patent Application Ser. No. 61/390,506, filed Oct. 6, 2010, for all purposes including but not limited to the right of priority and benefit of earlier filing date, and expressly incorporates by reference the entire content of Provisional Patent Application Ser. No. 61/390,506.

### BACKGROUND

Individuals who want to employ web-based solutions to track their health have limited options. Insurance companies will often provide web portals for individuals to access their account information, see past claims and find health related resources. Examples are myregence.com and myuhc.com among others. Insurance provided portals provide limited tools to evaluate their health, often don't show the results of the actual tests, and don't transfer their health information if the individual changes insurance providers.

Third party web services offer similar management and tracking services to those offered directly by insurance providers. For example, Google Health allows individuals to store all their health related information, integrate with other third party health services, i.e. FitBit.com, and generate reposts based on their health trends. Often, these services require the individual to enter lab results and information manually.

Requiring manual entry of data such as weight, health level, exercise and other relative data leaves the system prone to human error or deception, If the data being entered is incorrect then the results, trending and health recommendations will be incorrect.

Additionally the services discussed above often rely on relative information and not quantitative information. Relative information about the user (weight, height, activity levels) does not provide a common baseline to property compare one or more individuals health. Quantitative information such as blood test results provides an unbiased understanding of an individual's health The unbiased use of blood test results enable the disclosed system to grade each individual against the same criteria. also enables the system to understand the comparison between the grade of one or more individuals based on results from the same test.

Insurance firms provide individuals' insurance in exchange for a payment. There are many different types of insurance offered by many firms, for example health, life, and auto to name a few common types. When an individual applies they provide an insurance firm with key information that the insurance firm then uses to classify the individual. For example, life insurance firms use a multitude of information when creating a classification for an individual, The information gathered relates to an individual's age, health and life style. The age of the individual is factored into the cost an individual will pay, The older an individual is the more they will pay. Negative health factors will also increase the cost an individual pays, Lifestyle is also a large factor in the classification and premium payment. Lifestyle factors can include tobacco/nicotine use, SCUBA diving, flying, or extreme and dangerous sports. The number of negative lifestyle risk factors an individual has will increase their cost.

The payment (also known as premium) an individual pays is determined based on their classification. The number of factors determined to be negative or risky will affect how an individual is classified. Basic health classes for life insurance are: Preferred Best, Preferred, Standard Plus, Standard, Preferred Tobacco or Table Ratings. Individuals who are classified Preferred Best will have a lower payment versus individuals classified as Table Ratings.

Online services such as insurance.com, among many others, offer individuals the ability to provide basic information about them and view potential rates from insurance firms. The individual cannot determine their final classification and rate without first receiving a health check-up, blood test or other test required by the insurance firm. Again, these services are susceptible to human error and/or deception.

Prior art provides individuals a web portal to manage their health data, track specific types of health related information and discover potential insurance costs based on answers to preliminary age, health and lifestyle questions. These web services are provided directly by insurance companies, limiting the user to their portal features and tools. Third party websites offer a solution not limited to a specific insurance provided portal but which requires manual entry of user data, has limited analytics, and does not provide an interface for insurance companies to offer rates based on finalized health information. Further, insurance firms or web services offering a rate comparison only receive basic information from individuals requesting coverage, limiting their ability to provide the best rate to individuals.

A service that gathers enough quantitative or relevant information to properly classify an individual prior to engagement with product or service companies has eluded those skilled in the art, until now.

A solution that allows insurance or other services companies to bid on providing coverage for classified individuals has eluded those skilled in the art, until now.

A solution that provides an individual with a health tracking and grading that further allows them to use their information to receive products and services targeted at their specific health status or needs, has eluded those skilled in the art, until now.

A solution that provides an individual with information indentifying one or more reasons for a change in health status and products or services relating to the change, has eluded those skilled in the art, until now.

It would be advantageous to provide an online service that enables individuals to aggregate their information for the purposes of acquiring offers from product and service companies.

It would also be advantageous to provide a system that used multiple factors, both quantitative and relative, to classify individuals.

It would also be advantageous to provide a system that fulfills the product and services delivery to one or more groups of classified individuals.

It would also be advantageous to provide a system that enables insurance firms to bid on providing insurance coverage for a group of classified individuals.

It would also be advantageous to provide a system that enables insurance firms to receive analytic reports based on a group or individuals without releasing individual identity or reducing privacy.

### SUMMARY

The present inventive system and method relates to web services and toots to provide individuals with the ability to aggregate their various health related accounts, manage and visualize health related data, analyze their health data and, further, to a web service that enables products and services to be targeted to a group of individuals within a selected health grade.

In accordance with the present disclosure, there is provided a system and method for aggregating individual data, grading an individual based on their data, classifying an individual based on their specific rating and providing information related to the factors for the individual's grade and/or classification. Further, the system enables an individual to opt-in to being offered products and services, for example insurance, wherein their data, without personal identifying information, is used to classify them for service providers purposes. Even further, there is provided a system that enables services firms to place bids on providing products and services, for example insurance, to a group of individuals. The provided system contains methods to aggregate an individual's information, grade the individual and provide trends of their health and their health compared to others of similar age, health status and life style. The provided system supports analytical reporting to service and marketing firms to understand the habits, taste and trends among classified individuals, without providing any uniquely identifying information.

### BRIEF DESCRIPTION OF THE DRAWINGS

A complete understanding of the present disclosed system and method may be obtained by reference to the accompanying drawings, when considered in conjunction with the subsequent, detailed description, in which:

FIG. 1 is an illustration of the system and its components;

FIG. 2 is an illustration of the data aggregation component;

FIG. 3 is a flow chart of the individual grading process;

FIG. 4 is a flow chart of the classification process; and

FIG. 5 is a flow chart of the service bidding process.

For purposes of clarity and brevity, like elements and components will bear the same designations and numbering throughout the Figures.

In the following discussion, many specific details are provided to set forth a thorough understanding of the present invention. It will be obvious, however, to those skilled in the art that the present invention may be practiced without the explicit disclosure of some specific details, and in some instances of this discussion with reference to the drawings, known elements have not been illustrated in order to not obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in either hardware, software, firmware, or some combination thereof. In some embodiments the functions may be performed by a processor, such as a computer or an electronic data processor, in accordance with code, such as computer program code, software, and/or integrated circuits that are coded to perform such functions. Those skilled in the art will recognize that software, including computer-executable instructions, for implementing the functionalities of the present invention may be stored on a variety of computer-readable media including hard drives, compact disks, digital video disks, integrated memory storage devices and the like.

Furthermore, the following discussion is for illustrative purposes only and discusses the present invention in reference to various embodiments which may perhaps be best utilized subject to the desires and subjective preferences of various users. One of ordinary skill in the art will, however, appreciate that the present invention may be utilized in a great variety of forms in learning environments of any type. Unless explicitly stated, the method embodiments described herein are not constrained to a particular order or sequence. Additionally, some of the described method embodiments or elements thereof can occur or be performed at the same point in time.

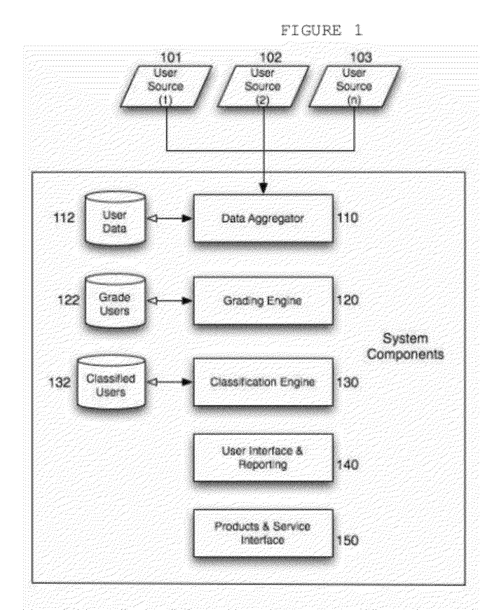

FIG. 1 is an illustration of the system and its various components. The system is configured to receive user data from a variety of sources 101,102,103 that a user determines to share. In a preferred embodiment an input source is a blood-testing lab or clinic that provides test results from each user. Other preferred input sources are mobile devices that provide real-time information regarding the individual, third party services that specialize in tracking specific types of user data, for example calorie management, diabetes or weight management services.

The data aggregator component 110 is responsible for receiving all the data from the input sources, The data aggregator is further responsible for ensuring only the key data required by the system is extracted, formatted, normalized and stored in the database 112.

The grading engine 120 evaluates the data stored in the database 112 and then grades, also referred to as rating, the individual user. The grading engine takes in each data point a user has associated with them. Each data point is configurable to be weighed differently in the calculation for the user grade. Additionally the user can be graded on specific subsets of their data. For example, in the preferred embodiment using blood data test results a user would receive a higher grade fur having low cholesterol, while receiving a lower grade due to higher than normal white blood cells—implying the individual might be sick. The grade for each user is stored associated with their data, 122. The grading engine can operate independently or in conjunction with the classification engine 130,

The classification engine operates by grouping users of a similar grade or rating. The number of groups or classifications can be configured to change as necessary by adjusting the threshold for each group rating and the number of classification groups. Clustering (grouping) algorithms are well known in the art. The classification engine is configurable to use any variety of clustering algorithms depending on the requirements for performance, data volume or other constraints. For example, the classification engine is configurable to use agglomerative or divisive hierarchical algorithms to successively group together (classify) individuals with similar ratings. Likewise the classification engine is configurable to use partitional algorithms whereby the users are classified on a preconfigured time basis or each time a request fro classification is received. The classification engine stores the classified users 132 for access from other components within the system.

Additionally, the system comprises quality assurance methods to ensure the system has not been ‘gamed’. The quality assurance methods assign varying weights (importance values) in the calculation of individuals' grade and classification. By varying the importance of data points in the grading and classification methods, the engine is configurable based on the number of quantitative and relative data points currently stored.

The user interface and reporting component 140 provides a web interface for users to access their health management account, The interface can be configured to display any variety of trending reports, specific data reports and alerts configured by the system or user based on selected health criteria. Additionally, the user can view how their health trends compare to others similar to them. The interface provides the user with the ability to select specific or all criteria to be in comparison and trending reports. Further the user interface comprises reporting tools that provide information regarding the factors that relate to an individual's health grade or classification. Providing a user configurable web interface to access and display stored information is well known to those skilled in the art.

The products and services interface 150 provides health product companies and services companies such as insurance firms an interface to display, among other features, the number of classifications, the number of individuals within each classification, and the health factors that lead to the classification of the users within each classification. In a preferred embodiment there is provided an interface whereby an insurance firm can bid to cover the individuals within one or more classifications at a set price. The price can also be set within a range of high-to-low based on the number of classifications selected by the insurance firm. The insurance interface includes a reporting tool that enables insurance firms to request analytical reports on trends from one or more classified groups. For example, in the preferred embodiment of health and fife insurance, an insurance firm may want to know what factors cause individuals to be classified as Preferred. The reporting tool will compare the key factors between individuals who were classified as Preferred versus those who were classified as Preferred Best. The reporting system can also report on trends within one or more classified group of individuals. At no time is the identity of the individuals provided. Rather a generic grouping of users and their data is all that is provided. The technologies and techniques for providing a dynamic web interface to access, display stored information and receiving input is well known to those skilled in the art.

In a further embodiment the system can be configured to perform analytics on the user data as discussed above for the purposes of recommending products to users. For example, if a user's rating is Preferred because their cholesterol is too high the system is able to recommend food, supplements and medication known to tower cholesterol. When the user lowers cholesterol they would be reclassified as Preferred Best and receive a tower insurance rate.

In another embodiment of the invention the user can track their location and health data through a mobile device. A mobile device can be any one of a phone, PDA or other device known to the system as an input source illustrated as 101, 102, 101 In an example embodiment a mood tracking application provides the user an interface to quickly capture their mood. The interface provides a selection of moods either in text or visual representations. The user can quickly select one of the provided moods. The application captures the user input and the location of their device the selection was made, This data is then sent to the system as described above. The data is stored associated with that users account. As described above the user can access the system and see trending reports relating to their mood trends. The real-time capture of health related information allows the health system and grading engine to holistically understand a users health and its relation to others of similar health grades.

In an even further embodiment one or more of the sources 101, 102, 103 is a mobile device with support for third party health devices. In this embodiment the mobile device integrates with a device that is used by the individual to capture and report health information directly. For example, third party devices may include a home blood test used by individuals with diabetes or a blood pressure monitor.

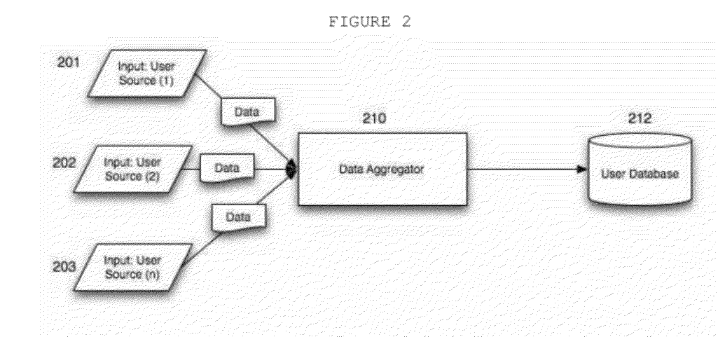

FIG. 2 is an illustration of the data aggregation component. The user registers one or more sources 201, 202, 203 with the system. The data aggregator component 210 receives data from each source. The data can be received upon request from the data aggregator component (pull) or from the source on a timed or ad-hoc basis (push). in a preferred embodiment the data aggregator will parse, format and store the data associated with a user in a database 212. The data aggregator can be further configured to receive multiple types of information and format them to a common format for storage and use within the present system.

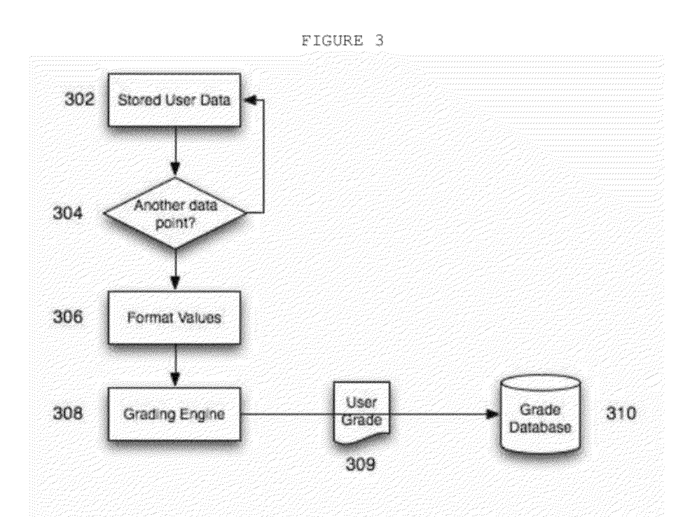

FIG. 3 is a flow chart of the individual grading process. The process starts by requesting the stored user data 302. Any number of data points can be stored depending on the number of sources and the type of sources the user has connected to their account. The process repeats 304, gathering all relevant data points for the grading request. The grading request can be on all data associated with that users health or a subset such as blood, mood, etc. Once the data points are all selected or gathered the process formats 306 them for the grading engine processing 308. The grading engine assigns each individual a grade on his or her total health or the subset of his or her health. The user grade 309 is then stored in the database 310 associated with that individual user.

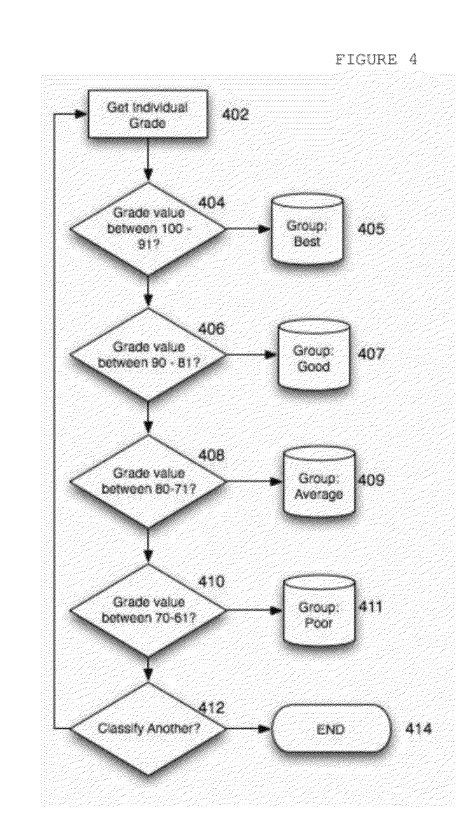

FIG. 4 is a flow chart of the classification process. This process presents a simplified version of grouping based on an individual grade. The process beings by the classification component receiving an individual user's grade 402. The process then determines if the grade falls within a given range 404, and if so it stores that user in the associated group 405. If the user grade does not fall within range of the first classification level, then the process checks against the next classification level 406. If the grade is within the set range for this classification then it stores it with the associated group 407, otherwise if not it then checks to see if the grade is within the next classification level 408. If the grade is within the set range for this classification then it stores it with the associated group 409, otherwise if not it then checks to see if the grade is within the final classification level 410 and stores if accordingly 411. Once the user has been classified, the process checks to see if there is another user to be classified 412. If so, the process repeats otherwise the classification process end 414. As discussed above the classification can be configured to use any variety of grouping or clustering algorithms, required by the system.

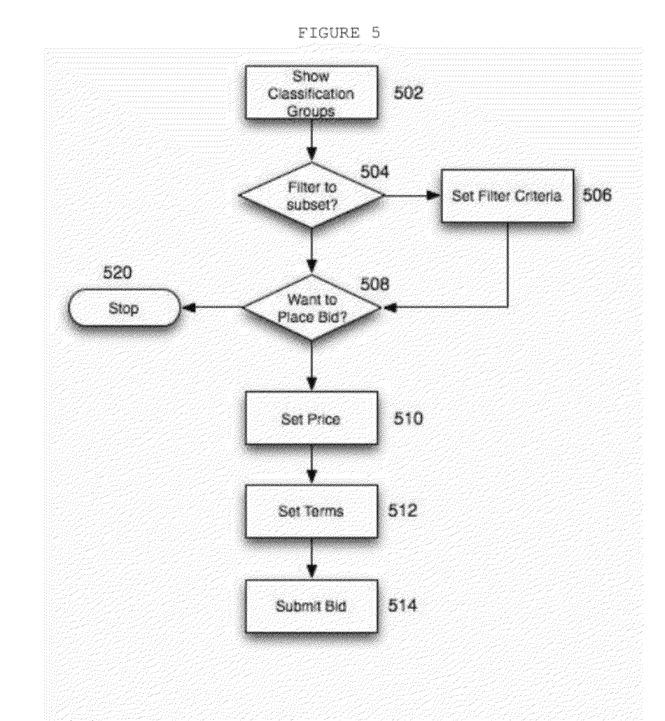

FIG. 5 is a flow chart of the service provider bidding process. By way of example and without limitation, the service provider can provide insurance services, health services or personal services. A service provider accesses the system enabling them to bid on one or more classified groups. The classified groups are shown 502 with the number of individuals within each. No identifying information is presented. In a further embodiment the interface provides a list of key attributes about the individuals within each classification. The attributes show the positive and/or negative factors that caused an individual to fail within a specific classification. The interface provides a tool that allows the service provider to filter a classified group 504 based on one or more criteria 506. For example, a classified group of Preferred might contain 100 people that range in age between 22-45. The service provider can filter based on age of only wanting to bid on individual between the ages of 25-30. Once the classification or a subset of a classification has been selected, the process confirms the insurance provider wants to place a bid to provide coverage 508. If the selection is ‘no’ the process ends 520. If the selection is ‘yes’ then the service provider is provided an interface to input a proposed price for coverage 510. In a further embodiment the service provider can seta range and then finalize the price with each individual that accepts the proposed coverage terms. Next the service provider sets specific terms 512 relating to the proposal. Terms can be configured for each type of service or customized by the service provider. For example, if the service is insurance, terms can specify the coverage type (health, life, auto), offer expiration time, or final requirements upon acceptance of coverage. At the final step 514 the service provider reviews their bid proposal for coverage and submits it to the system. The system then determines which individuals were within the selected classification and sends them a notification message regarding the service provider's proposal. As discussed above the interface is a web portal interface, of which the difference in technologies and implementation trade-offs are well known in the art.

Thus, in summary, it can be seen that what is described in this disclosure is a system that accepts and aggregates user health information, analyzes the information, classifies the individual based on quantitative data and provides a method for product and services firms to make offers to individuals of a given classification.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. A system for providing health-related products and services, comprising:
a data aggregator configured to receive user data from a plurality of user sources for a plurality of individuals, the data aggregator being further configured to extract key data from the user data;
a user database configured to receive and store the key data;
a grading engine that receives the key data and assigns at least one user grade based on the key data, each particular user grade in the at least one user grade corresponding to a particular individual in the plurality of individuals, each particular user grade in the at least one user grade being related to the key data for a particular individual in the plurality of individuals;
a user grade database configured to receive and store the at least one user grade;
a classification engine to assign individuals to two or more classifications based on the individuals' respective user grades, each classification reflecting a particular user grade;
a classification database configured to receive and store the two or more classifications; and
a products and services interface that enables each of one or more health product and. services companies to oiler a product, a service, or both, to one or more individuals in at least one classification.

2. The system of claim 1 wherein at least one user grade is a numerical value calculated based on the user data associated with the at least one user grade.

3. The system of claim 2 wherein the user data associated with the at least one user grade comprises one or more lab test results related to an individual.

4. The system of claim 2 wherein the user data associated with the at least one user grade comprises weight management information related to an individual.

5. The system of claim 2 wherein the user data associated with the at least one user grade comprises nutritional information related to an individual.

6. The system of claim I wherein the products and services interface denies the one or more health product and services companies access to personally identifying information relating to at least one individual in the plurality of individuals.

7. A method for assigning a user grade to an individual, comprising:
receiving data from one or more data sources at a data aggregator, the data comprising one or more data points;
formatting the data;
storing the data in a user database;
receiving a grading request at a grading engine, the grading request being related to a set of relevant data points, the set of relevant data points being selected from the data;
gathering the set of relevant data points;
formatting the set of relevant data points;
assigning the user grade based on an analysis of the set of relevant data points; and
storing the user grade in a grade database.

8. The method of claim 7 wherein at least one of the set of relevant data points comprises lab test results.

9. The method of claim 8 wherein at least one of the lab test results comprises blood test results.

10. The method of claim 7 wherein at least one of the one or more data points comprises health related information received in real time.

11. The method of claim 7 wherein at least one of the one or more data points comprises user mood data.

12. The method of claim 7 wherein at least one of the one or more data points is received from a mobile device.

13. The method of claim 7 wherein at least one of the one or more data points is received from a third party health device.

14. The method of claim 7 wherein at least one of the one or more data points is received on a timed basis.

15. A method for grouping a plurality of individuals into a classification, comprising:
assigning two or more user grades, each user grade in the two or more user grades being unique to a particular individual within a first plurality of individuals;
storing the two or more user grades in a grade database;
retrieving a first user grade from the grade database, the first user grade being associated with a first user;
determining whether the first user grade falls within a given range, the given range being associated with a classification;
if the first user grade falls within the given range, assigning the first user to the classification;
retrieving a second user grade from the grade database, the second user grade being associated with a second user;
determining whether the second user grade falls within the given range;
if the second user grade falls within the given range, assigning the second user to the classification; and
storing the classification in a classification database.

16. The method of claim 15, further comprising:
offering a product, a service, or both, based on the classification, to one or more individuals in a second plurality of individuals, each individual in the second plurality of individuals being associated with the classification.

17. A system for providing health-related products and services, comprising:
a data aggregator configured to receive user data from a plurality of user sources for a plurality of individuals, the data aggregator being further configured to extract key data from the user data;
a user database configured to receive and store the key data;
a grading engine that receives the key data and assigns at least one user grade based on the key data, each particular user grade in the at least one user grade corresponding to a. particular individual in the plurality of individuals, each particular user grade in the at least one user grade being related to the key data for a particular individual in the plurality of individuals;
a user grade database configured to receive and store the at least one user grade;
a classification engine to assign individuals to two or more classifications based on the individuals' respective user grades, each classification reflecting a particular user grade;
a classification database configured to receive and store the two or more classifications;
a user interface and reporting component that enables each of one or more individuals in the plurality of individuals to access his or her own respective key data; and
a products and services interface that enables each of one or more health product and services companies to offer a product, a service, or both, to one or more individuals in at least one classification.
